(19) United States
(12) Patent Application Publication
(10) Pub. No.: US 2018/0272485 A1
(43) Pub. Date: Sep. 27, 2018

(54) Device to Hold a Rivet Squeezer during Operation and to Store a Rivet Squeezer and Dies

(71) Applicant: Mark Winfield Scott, (US)

(72) Inventor: Mark Winfield Scott, (US)

(21) Appl. No.: 15/469,546

(22) Filed: Mar. 26, 2017

(51) Int. Cl. B23Q 3/10; B23Q 3/155

(52) U.S. Cl. CPC B23Q 3/102; B25D 17/046; B23Q 3/15553

(57) ABSTRACT

A squeezer holder device for the holding a hand rivet squeezer on a bench top for improved part control and squeezer operation. The squeezer holder device also provides convenient storage for a hand squeezer and associated dies. The central feature of the invention is the simple slot and die holders designed into a single block. The squeezer holder device allows the user to position a squeezer on any benchtop at a user selected orientation. The squeezer holder device enables accurate control of parts with one hand throughout squeezer operation by using the table surface to operate the lower squeezer lever. The squeezer holder device can be easily slid around a benchtop with the squeezer and dies between operations. When squeezer use is completed the squeezer holder device holds the squeezer in an upright space saving position with associated dies.

### BACKGROUND

### Field of the Invention

The present invention relates to a squeezer holder device to hold a hand rivet squeezer on a bench such that a user has full control of parts and the squeezer simultaneously. The squeezer holder device also provides a convenient means to relocate and store a squeezer and associated removable dies.

### Discussion of Prior Art

In the process of fastening sheet metal, plastic, or other parts, numerous rivets are used. Many rivets are deformed to their proper shape to fasten materials with a hand rivet squeezer tool, herein called a squeezer. In general terms a squeezer is a hand operated multilever tool. A squeezer consists of two lever arms with substantial leverage to squeeze a rivet between two dies. The dies are positioned opposite each other on the inside of a narrow neck which is a C shaped part at the head of a squeezer. Parts to be fastened are inserted between the dies for squeezing. Squeezers are also used to dimple materials for flush rivets. The dies are removable by hand. There are many dies for different types of rivets, dimples, and other types of surface modifications. There are other less frequent uses such as pressing small bearings. However, for brevity this description will focus on riveting operations.

Squeezers are a versatile tool because they can be used to fabricate small assemblies on a bench, or moved to a large assembly such as an airplane wing to perform rivet squeezing. Though different varieties of squeezers work well, none are self-supporting for bench top operation. Hence on a bench one hand must operate two lever arms and the other must hold two or more parts in position with an unsecured rivet. This is difficult to do well. Such operation leads to; rivets falling out of their hole due to awkward part and tool manipulation, misaligned parts with the squeezer dies which results in bent, often referred to as tipped rivets, loose fitting parts where the rivet fills an unwanted gap between the parts, and poor leverage on the lever arms. In the squeezer open position the separation between lever arms at about ¾ distance from the pivot, the optimum grasp position, is about the same distance as the distance from thumb to pinky on a person's hand. This makes grasping both lever arms difficult. One must grasp the two arms closer to the pivot where the distance between arms is reduced. Though this allows a grasp around both levers enabling a squeezing action, leverage is reduced and more hand force is required.

Clamps are available which attach to the squeezer neck to secure squeezers to tables or vices. This holds the squeezer in place but two hands are still required to operate the levers. Though clamps work well they require a dedicated location on a bench or a dedicated bench vice. Many people have limited work areas. A dedicated space for a squeezer clamp is not advantageous. Switching from bench top to large off bench assembly riveting and back requires the user to unfasten and refasten respectively the squeezer to clamps which is time consuming. Clamps are also not a means to store a squeezer and associated dies. Therefore the clamps are not optimal.

### OBJECTS OF INVENTION

There are two primary objects of the invention. The first is to provide an inexpensive, stable, rapidly detachable, reattachable, relocatable holder that can be used on any bench top, enabling a single person to securely hold and accurately locate parts in a hand rivet squeezer, while at the same time apply a full force greater than available from hands alone. The second object is to provide an easily relocatable squeezer holder with die holders such that all parts of the tool are in one place and can be moved across a table with one hand, or, with two hands easily moved to a storage location such as a shelf or cabinet.

Other and further objects will be explained hereinafter and are more particularly delineated in the appended claims.

### INVENTION SUMMARY

A table top support of a hand held rivet squeezer has been developed. The invention is a device consisting of a block approximately 4×4×1.3 inches in shape with a substantially flat bottom. The block has a slot in the approximate 4×4 inch face in which a squeezer neck fits. The slot is sufficiently wide to accept the narrow squeezer neck, yet narrow enough to laterally support the squeezer in an upright position without binding. The block is substantially flat and wide enough to laterally support the squeezer in an upright position. The operator holds the parts in one hand in the neck which is facing up. The other hand presses down on the top squeezer lever arm. The other squeezer arm presses against the table top thereby enabling the squeezing operation to be performed with one hand. The squeezer is able to rotate longitudinally in the block as it is used. The operator is able to use a large portion of their weight to press down on the top lever, much more than if hands alone were used. The squeezer block is free to move about a table or workshop since it is not mounted. The support block has multiple holes to store a variety of removable squeezer dies on either side of the slot.

Preferred and best mode design is more fully addressed in the next section.

### DESCRIPTION OF DRAWINGS

The invention will now be described in connection with the accompanying drawings, in which:

FIG. 1 is an isometric diagram of the squeezer holder with its constituent features.

FIG. 2 is a top view of the squeezer holder and its constituent features and an identified section cut line.

FIG. 3A a diagram of the squeezer holder in connection with a hand squeezer in the open position at the identified section cut in FIG. 2.

FIG. 3B a diagram of the squeezer holder in connection with a hand squeezer in the closed position at the identified section cut in FIG. 2.

### REFERENCE NUMERALS IN DRAWINGS

10 SQUEEZER HOLDER DEVICE

12 SLOT

14 SLOT INDENTATIONS

16 HOLES

18 SQUEEZER

20 UPPER HANDLE

22 LOWER HANDLE

24 NECK

26 MOTION DIE

28 STATIONARY DIE

30 TABLE SURFACE

### DESCRIPTION OF PREFERRED EMBODIMENT(S) OF INVENTION

The preferred embodiment in FIG. 1 is an isometric view of the squeezer holder device 10. The squeezer holder device 10 is preferably of single piece plastic construction with a substantially flat bottom. The squeezer holder device 10 may be blow molded or injection molded of high density polyethylene (HDPE) or similar plastic. However, any material sufficient to react loads induced under operation may be used. Slot 12 is predominantly centered in squeezer holder device 10. Slot indentations 14 are on either side of slot 12 such that fasteners that attach neck 24 to squeezer 18 are cleared within slot 12. The slot indentations 14 can be designed by those skilled in the art to accommodate geometries of particular squeezers and short throat necks. Multiple holes 16 are incorporated into the top face of squeezer holder device 10 with spacing to accommodate storage of multiple motion dies 26 and stationary dies 28 used in squeezer 18.

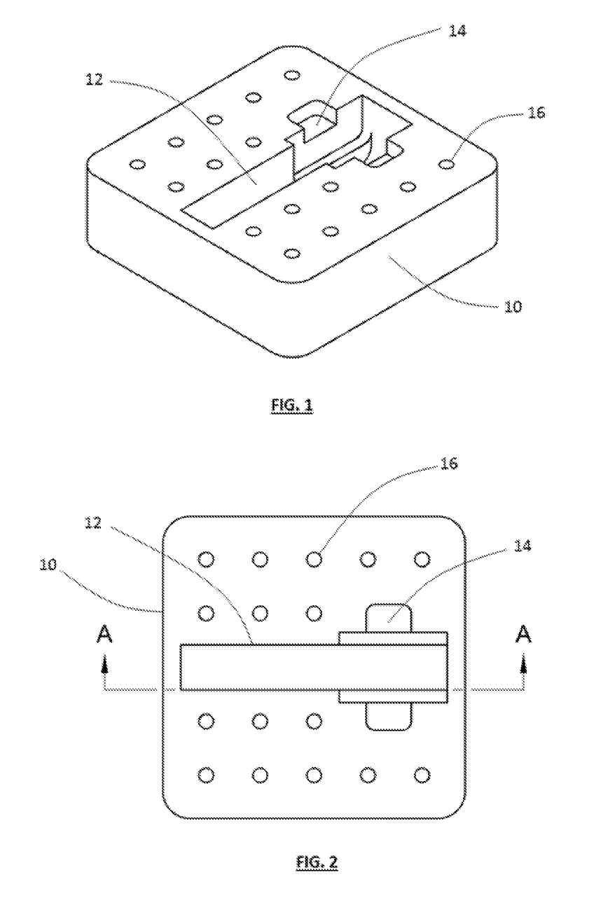

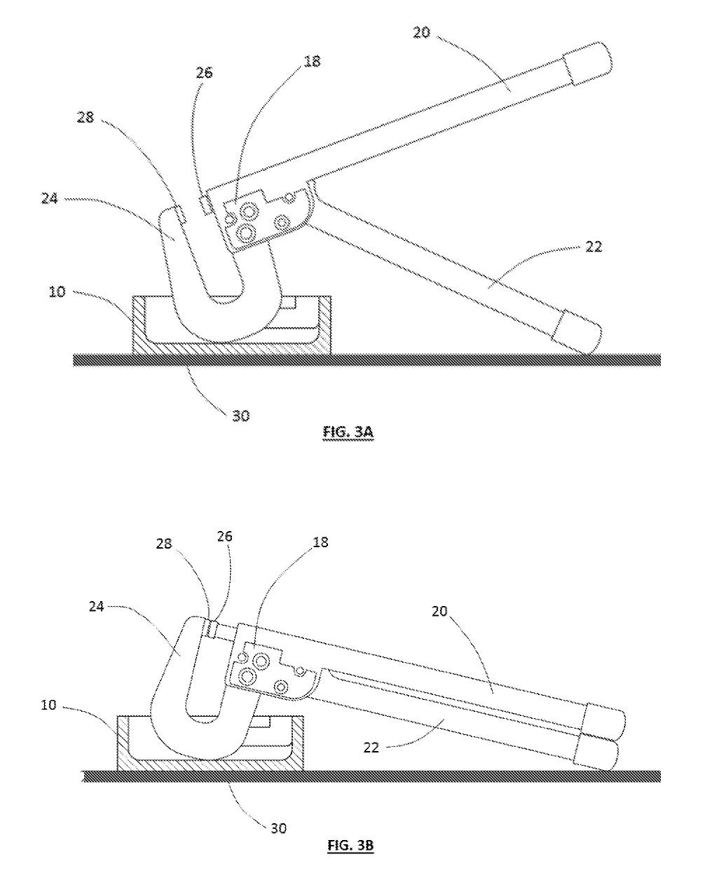

FIG. 2 is a top view of squeezer holder device 10 which clearly shows the relative placements of slot 12, slot indentations 14, and holes 16. Cross section A-A shown in FIG. 2 is provided to facilitate squeezer 18 operation description in squeezer holder device 10 in FIG. 3A and FIG. 3B.

FIG. 3A shows squeezer 18 in the open position. Lower handle 22 rests on table surface 30. Neck 24 resides in slot 12. The width of slot 12 is narrow enough such that squeezer 18 maintains an upright position without the operator touching it, yet loose enough to allow longitudinal rotation of neck 24 in the plane of squeezer 18. The operator with two hands is able to place parts to be fastened or dimpled in the opening of neck 24 and properly align the parts to be fastened or dimpled with motion die 26 and stationary die 28. Once the operator aligns the parts with motion die 26 and stationary die 28 the parts are placed in contact with one die or the other depending on the type of operation. Once contact is made the parts are stabilized in relation to squeezer 18. The operator holds the parts in contact with either motion die 26 or stationary die 28 with one hand and presses down on upper handle 20. Table surface 30 provides equal and opposite force on lower handle 22. This is one of the key features of the invention. Table surface 30 is used to advantage and enables single hand operation. The freedom of neck 24 to rotate in slot 12, as well as squeezer holder device 10 to slide on table surface 30, and lower handle 22 to slide if required ensures complete closure of the handles. The operator presses on upper handle 20 such that it moves downward and contacts lower handle 22. As this is accomplished motion die 26 moves towards stationary die 28. Once no gap remains between dies and the parts, squeezer 18 is then in the closed position as shown in FIG. 3B, and the operation is complete. Notice motion die 26 has moved towards stationary die 28 in FIG. 3B. The parts to be fastened would be between the two dies. Parts are released by pulling up on upper handle 20 and removed from neck 24 by the operator. Thereafter the sequence can be repeated.

Once all parts are completed motion die 26 and stationary die 28 are removed from squeezer 18 and placed in holes 16. The squeezer 18 remains in slot 12 within squeezer holder device 10. The entire assembly, squeezer 18 in squeezer holder device 10, can be easily slid anywhere desired on table surface 30 with one hand to make room for other operations. If desired, the entire assembly, squeezer 18 in squeezer holder device 10, with dies stored in holes 16 can be easily moved by an operator to another location for storage. The overall surface area taken up by assembly squeezer 18 and squeezer holder device 10 is less than squeezer 18 lying on its side with a separate die holder. The holes 16 which hold motion dies 26 and stationary dies 28 enable the squeezer holder device to conveniently locate all squeezer parts required for operation in one place thus reducing the potential for lost parts or delays finding them.

Also notice squeezer 18 can be rapidly removed and reinserted into slot 12 in device 10 with one hand. No clamps or fasteners of any kind are required. This facilitates rapid and easy squeezer use around the shop.

### Summary, Ramifications, and Scope

Thus the reader will see that the squeezer holder device provides a very convenient means to fasten or dimple sheet parts. The invention also allows the operator to exert more force downward with upper body strength and weight than available from hand strength alone as is the case with free squeezers. The squeezer holder device relies on the clever use of the table surface as the other “hand” and hence frees the other hand to accurately hold the parts together and aligned with the squeezer dies. This is far superior to using a squeezer with no supports. It is also superior to squeezers which have clamped necks since two hands are still required to operate the squeezer levers. The squeezer holder device allows the user to accurately hold parts together and in position through the entire squeezing process such that rivets do not fall out of their holes, parts are not misaligned, rivets do not get tipped, parts are tightly fastened together, and the operator gets good leverage on the lever arms. The squeezer holder device conveniently holds the squeezer anyplace on a table surface. The squeezer holder device also holds the dies conveniently with the squeezer either on a table or in storage. There are no clamps required. Therefore their associate cost and time to operate is eliminated. The lack of clamps enables the squeezer device holder to be used anywhere on a table surface.

While the above description contains many specifications these should not be construed as limitations on the scope of the invention, but rather as an exemplification of one preferred embodiment thereof. For example the number of holes can be changed. The overall dimensions as well as slot and indentation geometries can be changed to accommodate different neck sizes, various squeezers, or multiple squeezers. The material, color, and device shape can be changed. The slot position can be placed to one side or the other. The squeezer holder can be made from multiple parts. Accordingly, the scope of the invention should be determined not by the embodiment illustrated, but by the appended claims and their legal equivalents.

What is claimed is:

1. A device for supporting hand operated substantially narrow multilever machines comprising:
a) a substantially flat bottom surface and a slot,
b) whereby said slot is sufficiently narrow to laterally constrain a multilever machine yet sufficiently wide to allow longitudinal rotation freedom of multilever machine when operated,
c) whereby said surface is sufficiently wide to laterally support a multilever machine.

2. The device of claim 1 wherein said device includes a plurality of holes to hold multilever machine removable parts.

3. The device of claim 1 wherein said slot includes one or more indentations whereby the shape of the multilever machine fits into said slot and touches bottom of said slot.

4. The device of claim 1 wherein said device includes a plurality of holes to hold multilever machine removable parts and said slot includes one or more indentations whereby the shape of the multilever machine fits into said slot and touches bottom of said slot.
